(19) United States
(12) Patent Application Publication
(10) Pub. No.: US 2013/0155076 A1
(43) Pub. Date: Jun. 20, 2013

(54) DISPLAY DATA PROCESSING

(71) Applicants: Joseph F. Wodka, Hoffman Estates, IL (US); Nitya Narasimhan, Hopewell Junction, NY (US); Jehan Wickramasuriya, St. Charles, IL (US)

(72) Inventors: Joseph F. Wodka, Hoffman Estates, IL (US); Nitya Narasimhan, Hopewell Junction, NY (US); Jehan Wickramasuriya, St. Charles, IL (US)

(73) Assignee: General Instrument Corporation, Horsham, PA (US)

(21) Appl. No.: 13/325,163

(22) Filed: Dec. 14, 2011

(51) Int. Cl. G06F 15/16

(52) U.S. Cl. 345/502

(57) ABSTRACT

Disclosed are methods and apparatus for processing display data. The display data specify one or more presentations (e.g., digital signage information) for displaying to a user on an end-user device (e.g., a digital signage device). One or more processors receive one or more criteria (e.g., “user preferences”) and the display data. The one or more processors select some or all of the received display data. This selection may be dependent upon the one or more criteria. The one or more processors then provide, for display by the end-user device, the selected display data. This provision may be dependent upon the one or more criteria.

### FIELD OF THE INVENTION

The present invention relates to the processing of display data.

### BACKGROUND

Digital signage is a term that is typically used to refer to an electronic display, e.g., a liquid-crystal display (LCD), a light-emitting diode (LED) display, a plasma display, etc., for displaying electronic information (i.e., display data), e.g., advertising, etc.

Advertising is a common form of electronic information shown using digital signage. Digital signage is typically considered an out-of-home advertising delivery method. The advertisements shown using digital signage may include video content, images and text, etc.

Digital signage benefits over static signs or billboards by allowing content to be adapted to a context or audience. Messages can be targeted to be displayed at specific locations and at specific times. Digital signage displays are most usually controlled by computers or servers.

In-home advertising typically consists of television (TV) or radio advertisements and Internet advertisements (e.g., browser advertisements and “pop-up” advertisements). These advertising methods typically either stream random advertisements to a consumer or force a consumer to subscribe to a service or monitor different available opportunities, e.g., using an Internet browser.

Many consumers ignore or avoid advertiser messages streamed to them, e.g., during TV programming or over the Internet. For example, a user of a TV may skip through a TV advertisement using, for example, a digital video recorder. Furthermore, Internet users tend to be reluctant or do not have time to search through Internet or pop-up offers to find products or offers they are interested in.

### SUMMARY OF THE INVENTION

According to aspects of the present invention, methods and apparatus for processing display data are provided. The display data specifies one or more presentations (e.g., digital signage information and advertisements) for displaying on an end-user device (e.g., a tablet computer, television, or hardware dedicated to displaying digital signage) to a user.

In a first aspect, one or more processors receive (e.g., from the end-user device) one or more criteria which are set by the user and specifically related to the presentations. These one or more criteria may correspond to “user preferences.” The one or more processors also receive the display data (e.g., from a producer or provider of the display data). The one or more processors select some or all of the received display data. This selection may be performed such that the selected display data are in accordance with the one or more criteria. The one or more processors then provide, for use by the end-user device (e.g., for display on the end-user device), the selected display data. This provision of the display data may be performed such that the data are provided in accordance with the one or more criteria.

The one or more criteria may specify presentations (or types of presentations) that may or may not be displayed by the end-user device, a duration or frequency for which one or more presentations may be displayed by the end-user device, and priority information for various types of presentation. Thus users may set preferences as to what type of presentation is displayed on their devices and also how and when those presentations are displayed.

The one or more processors may receive profile information that specifies information relating to properties of the user or of the end-user device. The one or more processors may also receive one or more further criteria (which may be set by a provider of the display data and may include criteria specifying a population demographic to be targeted using the display data or a location or region to which the display data may be distributed). The selection or provision of display data may be dependent upon the profile information and the one or more further criteria. Thus providers of presentations may set preferences as to what type of user their presentations are displayed to, etc.

In a second aspect, one or more processors receive (e.g., from the end-user device) profile information that specifies information relating to properties of the user or of the end-user device. The one or more processors also receive the display data (e.g., from a producer or provider of the display data). The one or more processors also receive one or more criteria which may be set by a producer or provider of the display data and which may specifically related to the properties of the user or of the end-user device. The one or more processors selecting some or all of the received display data. This selection may be dependent upon the profile information and the one or more criteria. The one or more processors then provide, for use by the end-user device (e.g., for display on the end-user device), the selected display data. This provision may be dependent upon the profile information and upon the one or more criteria.

In any of the above aspects, the processors may remote from the end-user device, or one or more of the processor may reside in the end-user device. The end-user device may be installed in the home of the user.

The one or more processors may receive reward information which specifies a reward associated with a presentation which is to be awarded to the user if that presentation is displayed on the end-user device. Thus, users may be rewarded for displaying, or incentivised to display, e.g., by a presentation provider, certain presentations.

The one or more processors may receive a request for information (e.g., from the providers of the display data). The one or more processors may then compile some or all of the requested information and transmit this information to the requesting party. Thus, providers may request and receive information relating to the distribution and consumption of their presentations. This information may be used to facilitate, e.g., product recommendation or targeted advertising to the user.

### BRIEF DESCRIPTION OF THE DRAWINGS

FIG. 1 is a schematic illustration (not to scale) of an example of a network in which an embodiment of a method of providing digital signage information is implemented;

FIG. 2 is a schematic illustration (not to scale) of providers within the network;

FIG. 3 is a schematic illustration (not to scale) of a building within the network;

FIG. 4 is a schematic illustration (not to scale) of a management server within the network; and

FIG. 5 is a flow chart showing an example process performed by the entities of the network.

### DETAILED DESCRIPTION

In the following description, like reference numerals refer to like elements.

The following description is based on embodiments of the invention and should not be taken as limiting the invention with regard to alternative embodiments that are not explicitly described herein.

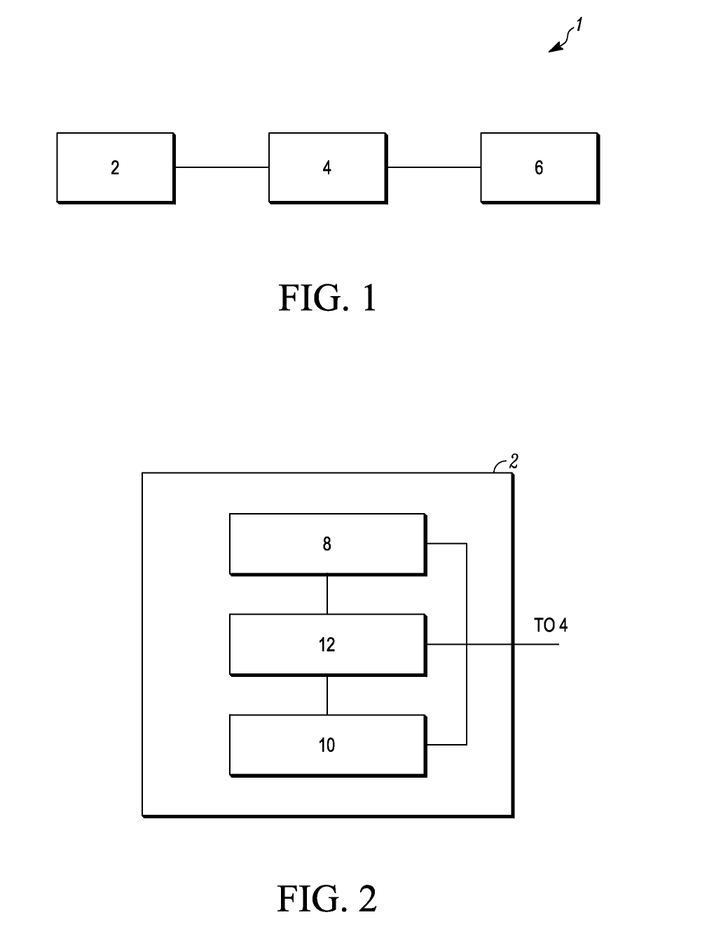

Referring now to the figures, FIG. 1 is a schematic illustration (not to scale) of an example of a network 1 in which an embodiment of a method of displaying information, e.g., advertisements, using digital signage is implemented.

The terminology “digital signage” is used herein to refer to an electronic display, e.g., an LCD, an LED display, a plasma display, etc., for displaying electronic information, e.g., advertising, etc.

The terminology “signage information” is used herein to refer to the digital (electronic) information that is displayed or to be displayed on digital signage (e.g., as images text, etc.). In other words, the signage information is display data.

The network 1 comprises one or more providers of signage information, hereinafter referred to as “providers” and represented collectively in FIG. 1 by a single box and the reference numeral 2. The network 1 further comprises a management server 4 and a building 6.

The providers 2 are described in more detail below with reference to FIG. 2. The providers 2 are coupled to the management server 4 such that, in operation, signage information provided (e.g., created or generated) by the providers 2 is sent from the providers 2 to the management server 4.

The management server 4 is described in more detail below with reference to FIG. 4. The management server 4 is coupled to the providers 2 and the building 6 such that, in operation, the management server 4 receives the signage information provided by the providers 2, processes the received signage information, and distributes the signage information to the building 6.

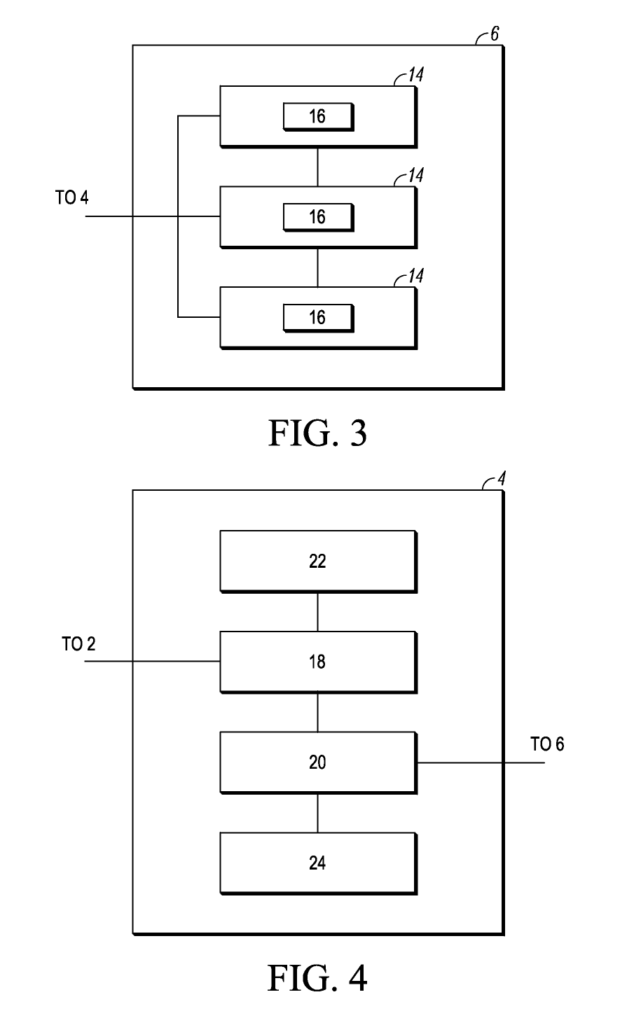

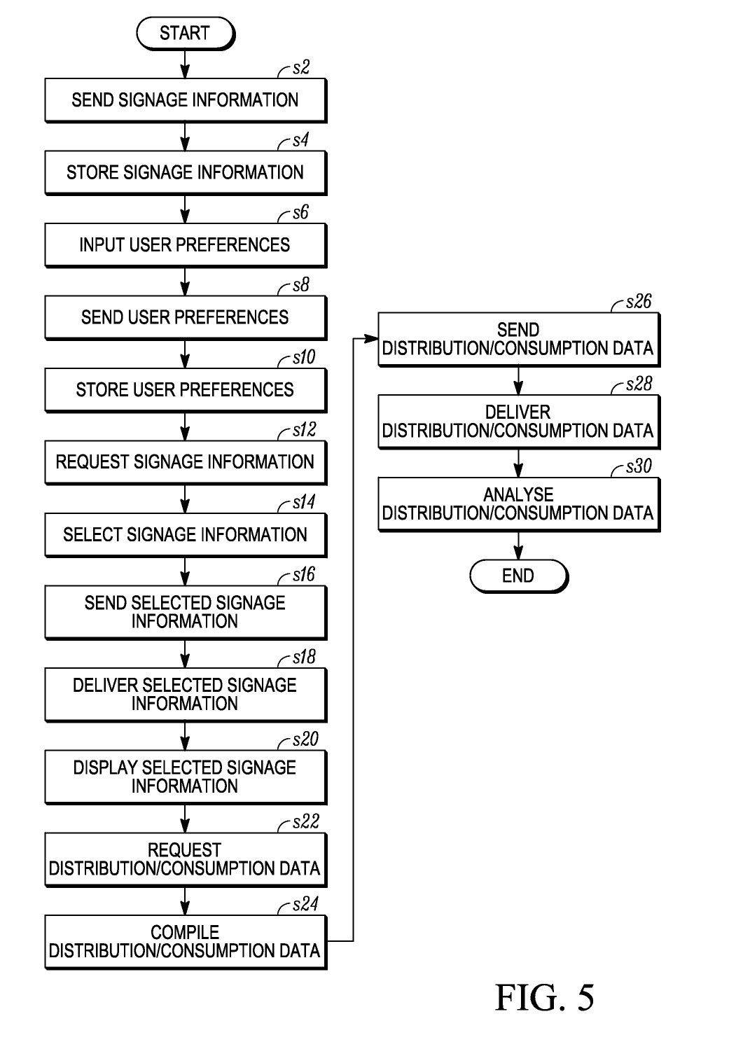

The building 6 is described in more detail below with reference to FIG. 3. The building 6 is coupled to the management server 4 such that, in operation, the building 6 receives the signage information distributed by the management server 4. The signage information is then displayed in the building 6 on digital signage as described in more detail below with reference to FIG. 5.

An embodiment of a method of providing signage information from the providers 2 to the building 6 via the management server 4 is described in more detail below with reference to FIG. 5.

FIG. 2 is a schematic illustration (not to scale) of the providers 2.

In this embodiment the providers 2 comprise one or more retailers (i.e., retailers of goods or providers of any consumer service), which are represented collectively in FIG. 2 by a single box and the reference numeral 8. The providers 2 further comprise a party that provides a digital signage management and signage information distribution service, which is hereinafter referred to as the “service provider” and is indicated in FIG. 2 by the reference numeral 10. The service provider 10 provides a service of providing signage information from the providers 2 to the building 6 as described in more detail below. The service provider 10 may be the owner or operator of the management server 4. The providers 2 further comprise one or more advertisers which are represented collectively in FIG. 2 by a single box and the reference numeral 12. In other embodiments, the providers may comprise one or more different types of providers of signage information instead of or in addition to those described in this embodiment.

The retailers 8 may be retailers of any type of goods or services. The retailers 8 are coupled to the management server 4 such that, in operation, the retailers 8 may send signage information (e.g., advertisements, offers, etc.) relating to the goods or services supplied by the retailers 8 to the management server 4 for distribution. Also, the retailers 8 may send additional information relating to the signage information to the management server 4, such as the population demographic to target with the signage information, what type of rewards may be offered to customers alongside the signage information, and details of the type of data to be returned to retailers 8 from the management server 4. This additional information may be used by the management server 4 as described in more detail below with reference to FIG. 5. Also, the retailers 8 are coupled to the advertisers 12 such that, in operation, the retailers 8 may provide the advertisers 12 with details of the goods or services supplied by the retailers 8 so that the advertisers 12 may produce signage information relating to those goods or services as well as additional information relating to the signage information.

The service provider 10 is the provider of the digital signage management and signage information distribution service that operates within the network 1 (to deliver signage information from the providers 2 to the building 6). The service provider 10 is coupled to the management server 4 such that, in operation, the service provider 10 may send signage information (e.g., advertisements, offers, etc.) relating to the service supplied by the service provider 10 to the management server 4 for distribution. Also, the service provider 10 may send additional information relating to the signage information to the management server 4, such as the population demographic to target with the signage information, what type of rewards may be offered to customers alongside the signage information, and details of the type of data to be returned to the service provider 10 from the management server 4. Also, the service provider 10 is coupled to the advertisers 12 such that, in operation, the service provider 10 may provide the advertisers 12 with details of the service it supplies so that the advertisers 12 may produce signage information relating to the service provided by the service provider 10 as well as additional information relating to that signage information.

The advertisers 12 are producers of advertising material. The advertisers 12 are coupled to the retailers 8 and to the service provider 10 such that, in operation, the advertisers 12 may receive details about respective goods or services supplied, sold, or to be supplied or sold from either or both of those parties. The advertisers 12 may then produce signage information relating to those goods or services. The advertisers 12 are also coupled to the management server 4 such that, in operation, the advertisers 12 may send the signage information produced by the advertisers 12 relating to the goods or service supplied by either or both of the retailers 8 and the service provider 10 to the management server 4 for distribution. Also, the advertisers 12 may send additional information relating to the signage information to the management server 4, such as the population demographic to target with the signage information, what type of rewards may be offered to customers alongside the signage information, and details of the type of data to be returned to the retailers 8, to the service provider 10 or to the advertisers 12 from the management server 4.

FIG. 3 is a schematic illustration (not to scale) of the building 6.

In this embodiment, the building 6 comprises a plurality of electronic devices, hereinafter referred to as the “devices” and indicated in FIG. 3 by the reference numeral 14. Each of the devices 14 comprises a display 16 on which signage information may be displayed. Thus, the each of the displays 16 is digital signage.

The devices 14 may all be the same type of device, or the devices 14 may include different types of device. The devices 14 may be, for example, televisions, computers, portable communications devices (e.g., mobile telephones), etc. The displays 16 on the devices 14 may include different types and sizes of display. A display 16 may be, for example, an LCD screen, an LED screen, a plasma screen, etc. A device 14 may comprise one or more displays 16.

A device 14 may be hardware dedicated to displaying signage information, i.e., a device may be a digital signage device. Alternatively, device 14 may be formed by installing a software agent into a device that primarily serves a different purpose (e.g., a tablet computer or a television). Devices 14 may be configurable by the device users. A device may have single or multiple displays 16 for displaying signage information.

A device 14 may comprise one or more cameras, barcode-readers or scanners, or microphones. A device 14 may be network connected to a different type of device that provides this capability. Such cameras or barcode-readers or scanners may be used by an operator to “scan” a physical element (e.g., a barcode). A microphone may be used to allow the user to provide audio input to device 14.

In this embodiment, the building 6 is the home of a user (e.g., an owner) of the devices 14. The terminology “user of a device” is used herein to refer to a party that interacts in some way with that device 14, for example, a user may be can be a single entity (e.g., a single end user) or a relevant group (e.g., “subscriber” associated with multiple individual user). In other words, in this embodiment the building is a private residence of the user of the devices 14. In other embodiments, the building 6 may be a different type of building, for example, an office block, a shop, etc.

The devices 14 may be situated at different locations (e.g., in different rooms) around the user's home 6. For example, one of the devices 14 may be a television located in the living room of the user's home, whilst a different one of the devices 14 may be a different (e.g., a smaller screened) television located in the kitchen of the user's home. A device 14 may be removable from the building 6, i.e., the device may be portable, e.g., a tablet computer or mobile communication device.

Each of the devices 14 is coupled to the management server 4 such that, in operation, signage information may be distributed from the management server 4 to one or more of the devices 14. This signage information may then be displayed on a portion (e.g., half or all) of the displays 16 of those devices 14. This process of distributing signage information from the management server 4 to one or more of the devices 14 is described in more detail below with reference to FIG. 5.

Furthermore, in this embodiment, one or more of the devices 14 are coupled to the management server 4 such that a user profile or preferences of the user as to how, when, and where signage information is displayed on the devices 14 may be transmitted from the one or more devices 8 to the management server 4. The user profiles or preferences may be transmitted from one or more of the devices 14 to the management server 4 to “register” the devices 14 with the management server 4, or the devices 14 may be registered with the management server 4 in a different way. The process of sending user preferences to the management server 4 from one or more of the devices 14 is described in more detail below with reference to FIG. 5. In other embodiments, user profile or preferences of the user may be transmitted or relayed to the management server 4 using a different type of device (i.e., a device other than a digital signage device 14).

A respective “display client” may reside on one any or all of the devices 14. A display client may act to register a respective device 14 and associated user preferences or profiles with the management server 4. A display client may also receive and render signage information items, process user inputs (in response to displayed signage information), process configuration updates received from the management server 4, or store and maintain a local cache of signage information content as appropriate for registered on-device profiles.

FIG. 4 is a schematic illustration (not to scale) of the management server 4.

In this embodiment, the management server 4 comprises an information selector 18, a display manager 20, a first database 22, and a second database 24.

The information selector 18 is coupled to the providers 2. In particular, in this embodiment the information selector 18 is coupled to the retailers 8, to the service provider 10, and to the advertisers 12. This is in such a way that signage information and associated additional information may be sent from the providers 2 to the information selector 18. The information selector 18 is arranged to process the received signage information and associated additional information as described below with reference to FIG. 5. The information selector 18 is also coupled to the display manager 20 and to the first database 22.

The display manager 20 is coupled to the building 6. In particular, in this embodiment the display manager 20 is coupled to each of the devices 14. This is in such a way that signage information and associated additional information may be sent from the display manager 20 to the devices 14 (e.g., by streaming data from the display manager 20 to any or all of the devices 14), and also such that user preferences may be sent from one or more of the devices 14 to the display manager 20. The display manager 20 is arranged to process received user preferences as described below with reference to FIG. 5. The display manager 20 is also coupled to the information selector 18 and to the second database 24.

In this embodiment, the management server 4 comprises two separate processing entities, namely the information selector 18 and the display manager 20. In other embodiments, the functionality provided by these separate entities may be provided by a single entity or by more than two separate entities.

In operation, the information selector 18 communicates with the providers 2 to negotiate terms (e.g., for signage information distribution, user incentives, etc.) and to return analytics (e.g., context, user engagement data) for any displayed signage information. In operation, the display manager 20 communicates with client devices 14 and manages the displays 16. The information selector 18 and the display manager 20 may communicate in a “cloud.” This separation of concerns or functionality of the information selector 18 and the display manager 20 tends to provide for expanded capabilities. For example, in operation the display manager 20 may communicate to the information selector 18 details of any or all of the following: displays 16 that are currently vacant or stale (e.g., showing something of little or no value), limitations of displays 16 (e.g., display capabilities and user constraints on use), and engagement history (i.e., how often users seem to interact with a display 16). In response to this communication, the information selector 18 may communicate details of an “offer” or “bid” which may comprise any of the following: items or signage information to be displayed, specific displays 16 or a class of displays 16 on which the signage information is to be displayed, incentives for the user based on time or location of placement, degree of user visibility or interaction, and quality of user (e.g., whether the user is a loyalty customer, influencer, etc.), and actions to be performed by a user in order for the user to be awarded those incentives. The display manager 20 may then decide if and when the signage information offered by the information selector 18 is actually shown on or dispatched to the displays 16 that it manages. If or when the signage information is displayed, the display manager 20 may additionally and optionally perform any of the following actions: apply rules to render or display appropriate reward or incentive information personalized to user or display context, use display layout, user preferences, or usage history to render a relevant subset of actions requested by the signage provider, and return clicks or actions or placement or visibility statistics to the information selector 18 (which in turn can then use the data to dynamically re-negotiate its bid to increase or decrease signage presence based on the level of engagement it has obtained).

The display manager 20 may decide what signage information is displayed on the devices 14, if or when the signage information offered by the information selector 18 is actually shown on or dispatched to the displays 16 it manages, and may also decide how the signage information is displayed on some or all of those displays 16. Some or all of this functionality provided by the display manager 20 may alternatively be provided by an entity other than the display manager 20. For example, a display client (or display agent) residing in a device 14 may provide some of the aforementioned functionality, e.g., the display manager 20 at the management server 4 may select certain types of signage information depending on a user's preferences and make this selected information available to a display client on a device 14, which may then distribute the information according to other of the user's preferences to different devices 14. In other words, the functionality of deciding what, when, or how signage information is displayed or provided for display may be provided by any of the entities in the network 1 or a combination of any of those entities, e.g., by a single module located centrally or by a number of modules distributed through the network 1.

Apparatus, including the management server 4, for implementing the above arrangement, and performing the method steps to be described below, may be provided by configuring or adapting any suitable apparatus, for example one or more computers or other processing apparatus or processors, or by providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM, etc., or any combination of these or other storage media.

In this embodiment, the above described system is implemented using a combination of in-home devices and external-to-the-home servers. However, in other embodiments, the system may be implemented in a different way, e.g., the system may be cloud based.

It should be noted that certain of the process steps depicted in the flowchart of FIG. 5 and described below may be omitted or such process steps may be performed in a differing order to that presented above and shown in FIG. 5. Furthermore, although all the process steps have, for convenience and ease of understanding, been depicted as discrete, temporally sequential steps, nevertheless some of the process steps may in fact be performed simultaneously or at least overlapping to some extent temporally.

FIG. 5 is a flow chart showing certain steps of an example process that may be performed by the entities of the network 1. In this example process, an embodiment of a method of providing signage information to user devices 14 for display to the user is implemented. The method of FIG. 5 is provided to illustrate an example method by which the entities of the network 1 may interact and should not be taken as limiting with regard to alternative methods.

At step s2, the providers 2 (i.e., any of the retailers 8, the service provider 10, and the advertisers 12) send signage information and any associated information (e.g., the population demographic to target with the signage information, what type of rewards may be offered to customers alongside the signage information, and details of the type of data to be returned to any or all of the providers 2) to the information selector 18 of the management server 4.

For example, the retailers 8 may instruct the advertisers 12 to produce digital advertisement material for a particular product. The retailers 8 may specify that the advertisement be targeted at people over the age of 18 and may include an offer of a 10% reduction from the purchase price of the particular product if a viewer of the digital advertisement (i.e., the user of the device 14 on which the advertisement is shown) fulfils certain criteria (e.g., the user permits the digital advertisement to be shown on the full display 16 of one or more of the user's devices 14 for a specific period of time). The retailers 8 may further specify that they wish to receive details of how many user devices 14 the advertisement was displayed on and at what times or in what locations (e.g., which towns or cities or countries, etc.) the advertisement was displayed. The advertisers 12 may then produce the digital advertisement material for the particular product and send that signage information, with the accompanying additional information, to the information selector 18 of the management server 4.

The offers or rewards offered to users of the digital signage may be dependent on the criteria fulfilled. For example, the user of a device 14 may be awarded a 10% discount if signage information is displayed on the whole of a display 16 of a device, whereas the user of a device 14 may be awarded only a 5% discount if signage information is displayed on half of a display 16 of a device. Also for example, a user's TV could be used to display signage information when powered-off or in stand-by mode. In exchange for allowing this, the user may be rewarded by having a portion of his electricity bill refunded. Rewards may or may not be monetary rewards or may be a combination of monetary and non-monetary rewards.

Thus, the providers 2 may advantageously specify criteria that need to be fulfilled by a user of the devices 14 if rewards are to be awarded to the user. Criteria may include, but are not limited to, the user interacting with a device 14 in any or all of the following ways: installing the device 14 or displays 16 in the building 6, uploading user preferences, “scanning” into a device 14 an item of interest, “scanning” into a device 14 a loyalty card or other identifier, sharing an advertisement or offer (e.g., using a social network to share an offer), partaking of an offer or opportunity, e.g., with an in-store purchase, using specific configurations or usage rules, bookmarking or transferring signage profiles or content, etc.

The ability for the providers 2 to specify what information they wish to receive back from the management server 4 (e.g., that they wish to receive details of how many user devices 14 the advertisement was displayed on, at what times, and in what locations, etc.) advantageously tends to provide that providers 2 have access to much richer information about signage distribution and information consumption than would conventionally be available to them. This tends to facilitate more effective advertising, targeted advertising, and the like.

At step s4, the information selector 18 sends the signage information and the associated other information received from the providers 2 to the first database 22 where the information is stored.

At step s6, the user (e.g., the owner) of the devices 14 inputs user preferences (i.e., preferences of the user as to how, when, and where signage information is displayed on the user's devices 14) in to one or more of the devices 14 in the building 6.

For example, a user of the devices 14 may specify or input the following preferences into one of the devices 14 (e.g., a tablet computer, a set-top box, or a personal computer). The user's preferences may state that on the television (a device 14) located in the user's lounge, signage information may only be displayed for a period of three minutes and at intervals of 30 minutes. The user's preferences may further state that on the television 14 located in the user's kitchen, signage information may only be displayed when that device is in “stand-by” mode, and furthermore that only signage information relating to food products or offers may be displayed on this device. The user's preferences may, for example, state details of how frequently particular digital information may be displayed (e.g., no more than once per day), how much space on the display 16 of a device 14 signage information may occupy (e.g., the full screen, half a screen, a quarter of a screen, etc.), and types of signage information that the user may wish not to be shown on certain devices (e.g., the user may not wish certain types of information to be displayed on a device located in a child's room). Thus, the user or owner of the devices 14 may specify preferences as to how, when, where, etc., signage information is displayed on those devices 14.

The user's preferences may specify that certain portions of the displays 16 of one or more of the networked devices 14 within the building 6 are to be devoted to displaying signage information based on certain criteria. Such criteria may include location-context tags that anchor a particular device for a particular type of content. For example, a user may specify that a refrigerator-mounted display screen only display food-related offers or opportunities, while a TV located in the user's lounge only shows signage information related to online purchases. Further profiles can be setup for a device to display different information or opportunities at different times.

The user's preferences may additionally specify that certain capabilities of certain devices should change (or be reduced or extended) at certain times. For example, preferences for a refrigerator-mounted digital display may specify that food-related advertisements or information (such as new recipes) may be displayed at certain times of the day, while at other times of the day, the device operates so as display the operating parameters of the refrigerator.

The user of the devices 14 may specify in the user preferences where the displays are installed in the building 6 or which area of a display 16 can be dedicated as signage. Also, the user may specify by whom the displays can (and cannot) be targeted. Such preferences may include allow or deny rules or details of preferred providers (e.g., a provider 2 with which the user has a loyalty card). Also, user may specify spatial and temporal attributes for displayable content i.e., where (on a display 16) and when (i.e., frequency, duration, visibility) signage information can be displayed. A persistence metric may be specified which allows some types or sources of content to be more persistent than others.

In other words, user preferences for a device 14 or display 16 may specify (but are not limited to) any or all of the following: location (i.e., where the display 16 is located or where the device 14 is installed), cardinality (i.e., the number of concurrent display regions on the display 16), properties of each display region (including for example its size, position on device display, visibility, and content-types supported by the display, etc.), allow-rules (i.e., when, where, and by-whom that device 14 or display 16 can be targeted), deny-rules (i.e., when, where, and by-whom that display 14 or display 16 cannot be targeted), temporality (e.g., specification absolute times, e.g., days or times-of-day etc., which the device 14 or display 16 may be targeted and also frequency and duration of which particular signage information may be displayed), targeting (i.e., specifying by whom, or for what, a specific area can be used or not, e.g., based on provider identity, keyword, or other content-specific property), persistence (i.e., specifying if some display areas are more persistent or pinned than others), and priority (i.e., specifying a relative priority for different display areas on a device such that if or where display areas overlap the higher priority display appears in front of the lower priority one).

At step s8, the user preferences are transmitted from the one or more devices 14 to the display manager 20 of the management server 4.

At step s10, the display manager 20 sends the user preferences received from the one or more devices 14 to the second database 24 where the user preference information is stored.

The user of the devices 14 may update the user preferences at any stage by implementing steps s6 through s10 for the updated user preferences.

The inputting of the user preferences to the display manager 20 (e.g., to dynamically manage and re-configure the signage installations) may be performed via a “central console,” e.g., hosted by the display manager 20 or by a device 14. This central console may be accessed from any capable signage-resident device 14 or from an independent networked device or browser. The central console may present static display profiles (including, for example, capabilities and rules configured on a per-device basis) and dynamic signage profiles (showing identifiers for the current signage information showing or queued up on each registered device 14). The central console may present rewards accrued by users (including reward points available, reward points redeemable, earned explicit rewards, and reward expiry dates or redemption requirements where applicable). The central console may enable editing of display profiles associated with any specific signage or display device. The central console may present users with an estimated value (e.g., monetary value) of each device 14 based on the degree and type of incentives they are likely to obtain given its current configuration. This may allow the users to optimise how their devices 14 display signage information to achieve maximum value. This may also benefit the providers 2 as exclusive offers can be targeted at “higher-pedigree” signage displays 16, while “lesser” rewards may be relegated to other displays 16. The central console may enable dynamic transfer of signage profiles between relevant devices. Thus, for example, any registered device 14 can be selected, and the user may be presented with a list of other devices 14 that can accommodate the rules or properties of the first, selected device 14. The user may then move or copy the profile (e.g., using an intuitive “drag and drop” technique) from a selected device to a device in the list. Transfer can then automatically update the ‘signage value’ at both source and destination devices. This tends to simplify the setup procedure. The central console may enable dynamic transfer or “bookmarking” of signage items. Thus, a user may see an offer for “25% off everything sale” on his mobile communication device display and choose to transfer or copy it to any or all of his other displays to make others in the user's household aware of the offer. Also, the user may bookmark an offer for a 5% discount on a particular product and save it this offer for later retrieval.

At step s12, depending on the latest user preferences stored in the second database 24, the display manager 20 requests that signage information fulfilling those user preferences be delivered from the information selector 18 to the display manager 20.

In this embodiment, if the user preferences indicate that on the display 16 of one or more of the devices 14 a certain type of signage information can now be shown, or can soon be shown, then the display manager 20 requests from the information selector 18 that signage information fulfilling the user preferences be delivered from the information selector 18 to the display manager 20. For example, the display manager 20 may perform this operation by sending a request to the information selector 20 for signage information fulfilling the user preferences and by sending details of the most recent user preferences.

At step s14, the information selector 18 selects, from the signage information stored in the first database 22, signage information that fulfils the user preferences. Furthermore, the information selector 18 selects from the signage information stored in the first database 22 signage information that, if delivered to the devices 14, fulfils any requirements or preferences set by the providers 2 of that signage information and specified in the additional information corresponding to that signage information (and stored in the first database 22).

At step s16, the information selector 18 sends the selected signage information to the display manager 20.

At step s18, the display manager 20 transmits the signage information delivered from the information selector 18 to one or more of the devices 14. This is performed such that the user preferences are fulfilled (or at least such that the displayed signage information does not contravene the user's preferences). For example, the display manager 20 may stream a type of signage information specified by the user at a time of streaming specified by the user. Furthermore, this is performed such that, when the signage information sent to the devices 14 from the display manager 20 is displayed on those devices 14, any of the preferences or requirements of the providers 2 that are specified in the additional information relating to that signage information are also fulfilled (or at least not contravened).

As mentioned above, the functionality of determining what, when, or how signage information is displayed or provided for display may be provided by any of the entities in the network 1 (e.g., the display manager 20) or by a combination of any of the entities in the network (e.g., by a combination of the display manager 20 and a display agent residing in a device 14). Thus, for example, the display manager 20 may transmit signage information delivered from the information selector 18 to one or more of the devices 14. A device 14 to which the signage information is delivered may further process or filter this information and display the signage information or distribute the information for display (on other devices 14) in accordance with the user's preferences (i.e., such that the user preferences are fulfilled or at least such that the displayed signage information does not contravene the user's preferences).

At step s20, the signage information that is transmitted to one or more of the devices 14 is displayed on the displays 16 of those one or more devices 14 according to the user's preferences.

Optionally, the following steps s22 through s30 may be performed in addition to step s2 through s20 described above.

At step s22, depending on the additional information relating to distributed signage information, the information selector 18 may request from the display manager 20 details of how and to where the signage information was distributed or details of how a user interacted with the signage information when it was displayed. For example, if a signage provider 2 had specified in the additional information relating to signage information that he wishes to receive details of how many user devices 14 the signage information was displayed on, at what times the signage information was displayed, and in what locations the signage information was displayed, the information selector 18 requests the display manager 20 that the display manager 20 send that information to the information selector 18.

At step s24, the display manager 20 compiles the information requested by the information selector 18. This information may be compiled from a record kept by the display manager 20 (e.g., stored in the second database 24) of how signage information was distributed at step s18 (i.e., a record of what signage information was sent to which device 14, at what times the signage information was sent for display, how much of a device display 16 is allocated to showing signage information, or where in the building 6 those devices 14 to which the signage information was sent are located, etc.).

At step s26, the display manager 20 sends the information requested by the information selector 18 to the information selector 18.

At step s28, the information selector 18 transmits the information delivered to it from the display manager 20 to the relevant provider 2 (e.g., to the party that desires the information as to how the signage information was distributed and consumed).

At step s30, the provider 2 that receives the distribution or consumption information for the signage information analyses that information, e.g., so as to modify how signage information is generated and distributed.

Thus, an example process performed by the entities of the network 1 in which an embodiment of a method of providing signage information to user devices 14 is implemented is provided. The user of the devices 14 advantageously has some degree of control over how signage information is distributed and displayed.

In the provided method and apparatus, the information selector 18 resides in a central location and interacts with the providers 2 to maintain their signage requirements (e.g., for advertisements, campaigns, etc.) and the associated rewards rules. The information selector 18 further provides, from this central location, related analytics and advertising-effectiveness metrics based on signage properties and signage deployments. At the centralised location the information selector 18 interacts with the display manager 20 to negotiate and target signage information delivery to specific displays 16 (or to users) and to retrieve related signage-usage analytics and reward allocations. The display manager 20 also resides at the central location and maintains user profiles and associated signage profiles for that user. Also, the display manager 20 may host the “central console” that can be accessed by users to dynamically view, configure, or update signage profiles and monitor or redeem accrued rewards.

The above described method may advantageously be used to provide commercial signage information to a user or owner of devices which may function as digital signage devices. The display of such commercial information by the devices (in particular which of the user's devices display the information, when they display it, and how it is displayed) may advantageously be influenced by the user (e.g., by setting preferences or defining device behaviours). For example, a user can set rules that specify that a particular display can show signage information only at specific times, or in response to specific actions, or rules that allow only some portion of the display to be dynamically changed. Also, a user can specify different respective granularities or resolutions for different areas within a display (as well as being able to specify a granularity or resolution with which signage information is to be displayed on the whole display). Advantageously, a user may specify that offers or signage information from certain parties (e.g., stores with from whom the user receives “loyalty rewards”) appears in one area of a display (constantly or until the user interacts with the offer or signage), whilst at the same time a different area of the same display dynamically displays signage information from different parties.

Users or owners of devices can advantageously be incentivized to watch or display commercial signage information in their own home. This may be achieved for example by allowing the user to set preferences for the displayed content or offering the user some sort of reward for allowing display of the signage information on the user's devices.

Incentives may be offered or awarded to the user in exchange for installing digital signage in his home. For example, in exchange for installing a digital signage device in his home, the user can accumulate “reward points” by performing certain actions (e.g., partaking of an offer, selecting or clicking on an advertisement, sharing an advertisement with friends, reviewing a product, allowing his product review to be used by an advertiser, etc.). The performance of such actions by a user tends to be useful information for the providers of signage information. Having a user respond and interact with or follow-up on advertisement or offers tends to provide an advertiser or retailer or service provider with more useful information than would conventionally be available. Other types of incentives offered to users may include (but are not limited to) limited-time or priority offers, early access information relating to sales events, in-store events, and pre-release events. Also, users may be allowed to leverage accumulated “reward points” for increased loyalty rewards (e.g., further discounts) or merchandise from local and affiliate partners.

The users or owners of the devices may advantageously set or modify their preferences to include details of the user's preferred retailers or details of the users' loyalty cards or store cards. This tends to allow, for example, signage information from the users' preferred retailers to be prioritized and allow the users to receive further benefits, e.g., in the form of loyalty rewards or discounts. Such loyalty rewards or discounts may be one-time coupons that a user scans into a portable device (e.g., a portable communication device, e.g., a mobile communication device or a tablet computer) from the displayed signage information. This advantageously tends to provide the advertiser or retailer the ability to track or assess the influence of the advertisements and also facilitates the advertiser or retailer in switching the user or owner of the device to a different product, e.g., by targeting him with personalised special offers.

The in-home digital signage may advantageously be used (by a retailer or advertiser) to influence the user's typical schedule. For example, if a particular retailer experiences heavy traffic or footfall at their store on a certain day of the week and would like to spread the load on their facilities to different days, special offers, redeemable only on other days, could be sent to digital signage devices. Thus, consumers are encouraged to shop on different days. The offers may be made available to a consumer based on that consumer's loyalty-card history. Thus, the in-home digital signage may be used to influence behavioural changes in a consumer.

Location information for a user (i.e., location of the building or user's home) may be provided when the user registers his devices to the digital signage service, sets his user preferences, or sets up a user profile. Advertisers or retailers may use this location information to target specific users (e.g., users within the locality of their outlets, etc). Similarly, a user may opt to display signage information from retailers or advertisers within the locality of the user's home.

The above described apparatus and method address a problem of facilitating retailers, service providers, advertisers, etc., to target consumers with out-of-home style signage in the home (or office) of the consumer. Possible reluctance of consumers tends to be reduced or alleviated by allowing them to set preferences as to how and when signage information is displayed in their home and by also rewarding the consumer for performing certain actions relating to the display of the signage information. Advantageously, placement of digital signage in the home of a consumer that is both beneficial to the consumer and the signage provider tends to be achievable through a combination of setting user and signage provider preferences.

The above described apparatus and method advantageously tends to extend the provision to consumers of out-of-home style signage to include provision in the consumer's home. This tends to benefit retailers, service providers, and advertisers in a number of ways. Firstly, more advertising opportunities are created. In particular, each additional signage display presents new space on which advertisements may be shown. Also, this allows for a greater number of and greater flexibility in the available “advertisement slots.” This advantageously tends to allow for business models that accommodate cheaper or more local advertisement slots. Secondly, a greater degree of engagement of consumers with advertisement tends to provided. In particular, consumers tend to be more likely to interact with ambient displays and to become more aware of brands and messaging (e.g., due to the persistence or repetition of the signage information). Thirdly, more accurate targeted advertising tends to be facilitated. This tends to arise from the ability of providers to target not just the device user but also the in-home location of digital signage, user-specific preferences (e.g., time or placement), and advertiser-specified criteria (e.g., campaign duration, keywords, placement).

The above described method and apparatus advantageously tend to provide that signage displays can be managed and coordinated across one or more user-owned devices (located at the user's home, on a mobile communication device, etc.).

In operation, it tends to be advantageously possible for one or more new devices (i.e., devices not previously present in the home and so not registered with the local display manager) to enter a building (e.g., a user's home) and register (e.g., automatically) with the local display manager. A local display manager may synchronize, or make coherent, signage information across the newly registered and previously registered devices. For example, the local display manager can ensure that, if signage information relating to a product is being already being displayed in the home, the new device does not at the same time display signage information relating to a competing product. Furthermore, this tends to allow for “Surround Sound Advertising” or “Surround Session Advertising,” i.e., coordinating advertisement messages shown on a plurality of the user's digital signage to “encompass” the user and enforce the message.

Furthermore, the disadvantages of conventional in-home advertising tend to be alleviated by the use of the in-home digital signage. For example, problems caused by audience and attention fragmentation (e.g., a user performing an unrelated task while, e.g., TV advertisements are being shown may mean that the user's attention is not always on the TV screen, and his awareness or engagement with the advertisements may be detrimentally affected) tend to be reduced by the use of persistent advertisements as may be provided by in-home digital signage. In this way, the above described system and method may advantageously be used to increase brand awareness and increase user recall of advertisements. Also for example, a problem of tracking, analysing, and monetising consumer behaviours (e.g., caused by consumers consuming content from various diverse sources) tends to be solved by the above described method and apparatus.

We claim:

1. A method of processing display data, the display data specifying one or more presentations for display on an end-user device to a user of that device, the method comprising:
receiving, by a first receiving processor, one or more criteria, the one or more criteria having been set by the user, the one or more criteria specifically related to the presentations;
receiving, by a second receiving processor operatively coupled to the first receiving processor, the display data;
selecting, by a selecting processor operatively coupled to the receiving processors, some or all of the received display data; and
providing, by a providing processor operatively coupled to the receiving processors and to the selecting processor, for display by the end-user device, the selected display data;
wherein condition (i) is that selecting is performed such that the selected display data are in accordance with the one or more criteria;
wherein condition (ii) is that providing is performed such that the display of the selected display data by the end-user device is in accordance with the one or more criteria; and
wherein either or both of conditions (i) and (ii) are fulfilled.

2. A method according to claim 1 wherein the processors are remote from the end-user device.

3. A method according to claim 1 wherein one or more of the processors reside in the end-user device.

4. A method according to claim 1 wherein the end-user device is a device installed in the home of the user.

5. A method according to claim 1:
wherein the one or more presentations specified by the display data are digital signage presentations; and
wherein the end-user device is a digital signage device.

6. A method according to claim 1 wherein:
if condition (i) is satisfied, then the one or more criteria are selected from a group consisting of: criteria specifying one or more presentations that may be displayed by the end-user device, criteria specifying one or more types of presentation that may be displayed by the end-user device, criteria specifying one or more presentations that may not be displayed by the end-user device, criteria specifying one or more types of presentation that may not be displayed by the end-user device; and
if condition (ii) is satisfied, then the one or more criteria are selected from a group consisting of: criteria specifying a duration for which one or more presentations may be displayed by the end-user device, criteria specifying a frequency with which one or more presentations may be displayed by the end-user device, criteria specifying priority information for various types of presentation, and criteria specifying how one or more presentations may be displayed by the end-user device.

7. A method according to claim 1 further comprising:
receiving, by a processor, profile information, the profile information being information relating to properties of the user or the end-user device; and
receiving, by a processor, one or more further criteria, the one or more further criteria having been set by a provider of the display data, the one or more further criteria specifically related to the properties of the user or the end-user device;
wherein condition (iii) is that selecting is performed dependent upon the profile information and the one or more further criteria;
wherein condition (iv) is that providing is performed dependent upon the profile information and the one or more further criteria; and
wherein either or both of conditions (iii) and (iv) are fulfilled.

8. A method according to claim 7 wherein the one or more further criteria are selected from a group consisting of: criteria specifying a population demographic to be targeted using the display data and a location or region to which the display data may be distributed.

9. A method according to claim 1 further comprising:
receiving, by a processor, reward information, the reward information specifying a reward, wherein the reward is associated with a presentation specified by the display data and is to be awarded to the user if that presentation is displayed on the end-user device.

10. A method according to claim 1 further comprising:
receiving, by a processor, a request for information;
compiling, by a processor, some or all of the information requested in the request for information; and
transmitting, by a processor, for use by an entity remote from the processor, the compiled information.

11. A method according to claim 10 wherein the request for information is a request for one or more items selected from a group consisting of: information relating to how one or more of the presentations specified by the display data are displayed by the end-user device, information relating to where one or more of the presentations specified by the display data are displayed by the end-user device, information relating to when one or more of the presentations specified by the display data are displayed by the end-user device, and information relating to how the user interacted with the one or more of the presentations specified by the display data and displayed by the end-user device.

12. A method of processing display data, the display data specifying one or more presentations for displaying on an end-user device to a user of that device, the method comprising:
receiving, by a first receiving processor, profile information, the profile information comprising information relating to properties of the user or of the end-user device;
receiving, by a second receiving processor operatively coupled to the first receiving processor, the display data;
receiving, by a third receiving processor operatively coupled to the first and second receiving processors, one or more criteria, the one or more criteria having been set by a provider of the display data, the one or more criteria specifically related to the properties of the user or of the end-user device;
selecting, by a selecting processor operatively coupled to the receiving processors, some or all of the received display data; and
providing, by a providing processor operatively coupled to the receiving processors and to the selecting processor, for display by the end-user device, the selected display data;
wherein condition (i) is that selecting is performed dependent upon the profile information and the one or more further criteria;
wherein condition (ii) is that providing is performed dependent upon the profile information and the one or more further criteria; and
wherein either or both of conditions (i) and (ii) are fulfilled.

13. A method according to claim 12 wherein the processors are remote from the end-user device.

14. A method according to claim 12 wherein one or more of the processors reside in the end-user device.

15. A method according to claim 12 wherein the end-user device is a device installed in the home of the user.

16. A method according to claim 12:
wherein the one or more presentations specified by the display data are digital signage presentations;
wherein the end-user device is a digital signage device.

17. A method according to claim 12 wherein the one or more criteria are selected from a group consisting of: criteria specifying a population demographic to be targeted using the display data and a location or region to which the display data may be distributed.

18. A method according to claim 12 further comprising:
receiving, by a processor, reward information, the reward information specifying a reward, wherein the reward is associated with a presentation specified by the display data and is to be awarded to the user if that presentation is displayed on the end-user device.

19. A method according to claim 12 further comprising:
receiving, by a processor, a request for information;
compiling, by a processor, some or all of the information requested in the request for information; and
transmitting, by a processor, for use by an entity remote from the processor, the compiled information.

20. A method according to claim 19 wherein the request for information is a request for one or more items selected from a group consisting of: information relating to how one or more of the presentations specified by the display data are displayed by the end-user device, information relating to where one or more of the presentations specified by the display data are displayed by the end-user device, information relating to when one or more of the presentations specified by the display data are displayed by the end-user device, and information relating to how the user interacted with the one or more of the presentations specified by the display data and displayed by the end-user device.

21. Apparatus for processing display data, the display data specifying one or more presentations for display on an end-user device to a user of that device, the apparatus comprising:
a first receiving processor configured to receive one or more criteria, the one or more criteria having been set by the user, the one or more criteria specifically related to the presentations;
a second receiving processor operatively coupled to the first receiving processor, configured to receive the display data;
a selecting processor operatively coupled to the first and second receiving processors, configured to select some or all of the received display data; and
a providing processor operatively coupled to the first and second receiving processors and to the selecting processor, configured to provide, for display by the end-user device, the selected display data;
wherein condition (i) is that selecting by the selecting processor is performed such that the selected display data are in accordance with the one or more criteria;
wherein condition (ii) is that providing by the providing processor is performed such that the display of the selected display data by the end-user device is in accordance with the one or more criteria; and
wherein either or both of conditions (i) and (ii) are fulfilled.

22. Apparatus for processing display data, the display data specifying one or more presentations for displaying on an end-user device to a user of that device, the apparatus comprising:
a first receiving processor configured to receive profile information, the profile information being information relating to properties of the user or the end-user device;
a second receiving processor operatively coupled to the first receiving processor, configured to the display data;
a third receiving processor operatively coupled to the first and second receiving processors, configured to receive one or more criteria, the one or more criteria having been set by a provider of the display data, the one or more criteria specifically related to the properties of the user or the end-user device;
a selecting processor operatively coupled to the receiving processors, configured to select some or all of the received display data; and
a providing processor operatively coupled to the receiving processors and to the selecting processor, configured to provide for display by the end-user device the selected display data;
wherein condition (i) is that selecting by the selecting processor is performed dependent upon the profile information and the one or more criteria;
wherein condition (ii) is that providing by the providing processor is performed dependent upon the profile information and the one or more criteria; and
wherein either or both of conditions (i) and (ii) are fulfilled.
